(19) United States
(12) Patent Application Publication
(10) Pub. No.: US 2026/0061233 A1
(43) Pub. Date: Mar. 5, 2026

(54) FIRE SHIELD

(71) Applicant: Paul Christensen, Seguin, TX (US)

(72) Inventor: Paul Christensen, Seguin, TX (US)

(21) Appl. No.: 18/825,073

(22) Filed: Sep. 5, 2024

(51) Int. Cl. A62C 3/02

(52) U.S. Cl. CPC A62C 3/0264; A62C 3/0271

(57) ABSTRACT

Water control valves, rooftop rotors, and infrared sensors are installed on a housing structure to perform a series of functions. An application on a mobile device is connected to a controller, the water control valves, rooftop rotors, and infrared sensors. The mobile device, through the application, is configured to receive alerts from the infrared sensors of any approaching fires. In response, the application can activate the water control valves and rooftop rotors. Upon activation, the water control valves and rooftop rotors will be activated to form a barrier around the housing structure.

### TECHNICAL FIELD

Embodiments of the invention relate to a fire shield safety system to protect homes and buildings from wildfires and other disasters.

### BACKGROUND

Many homes have currently been identified as at high or extreme risk due to wildfires or other diasters. Many homes and buildings are currently in regions of the country where wildfires and other diasters can occur more frequently than in other parts of the world. Further, a good number of these homes and buildings are not adequately protected from the risk of the wildfires and other natural disasters.

While homes and buildings are not prepared for the wildfires and disasters, the homes and buildings can occur significant losses. Burning embers can fall on home roofs from the wildfires and other disasters. The embers can damage the roofs and other parts of the homes and buildings. The damage can cause the owners significantly losses financially. The owners may also lack comfort and peace of mind when the home or building is not adequately protected from falling embers occurring from wildfires and other disasters.

A need exists to adequately protect homes and buildings from wildfires at any time interval. Moreover, the need also exists to enable owners to not suffer significant losses or lack comfort and peace of mind when wildfires and other disasters frequently occur near their homes and buildings. Therefore a system to safely and continuously protect homes and buildings situated near wildfires and other disasters is needed to keep the homes and buildings safe and intact.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to installing a fire shield safety system on a home or building to prevent wildfires and other disasters. At various positions on a housing structure, water control valves, rooftop rotors and infrared sensors are positioned. A mobile device can have an application installed that links the mobile device to a controller within the home or building, and also the water control valves, rooftop rotos, and infrared sensors. Further, the infrared sensors are configured to sense any wildfires that may be approaching the housing structure, and send alerts to the mobile application. In response, the user through the mobile device can activate the water control valves and the rooftop rotors to form a water barrier around the housing structure.

The rooftop rotors can configure the watter barrier around the housing structure to extend to at least forty feet from the housing structure.

The rooftop rotors can be configured to be positioned exterior regions on the roof of the housing structure.

In one aspect, the rooftop rotors can work in conjunction upon activation to form the barrier around an entire circumference of the housing structure.

In one aspect, the water control valves and rooftop rotors act in unison as a fire shield safety system upon being activated by the mobile device in response to a received alert from the infrared sensors.

In one aspect, the water control valves are situated to provide the water to the rooftop rotors to provide the barrier around the housing structure.

In one aspect, the infrared sensors can provide the alerts to the mobile device in multiple time intervals.

In one aspect, the barrier of water around the housing structure can extend greater than forty feet.

In one aspect, the rooftop rotors can from the water barrier in multiple time intervals.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1(A) illustrates a front view of one of the infrared sensors according to some embodiments;

FIG. 1(B) illustrates a front view of one of the water control valves according to some embodiments;

FIG. 1(C) illustrates a side view of one of the rooftop rotors according to some embodiments;

FIG. 1(D) illustrates a side view of the fire shield safety system with a controller, rooftop rotors, and mobile device according to some embodiments;

FIG. 2 illustrates a mobile device with an application according to some embodiments;

FIG. 3 illustrates a top view of the fire shield safety system forming a water barrier around the housing structure according to some embodiments; and

FIG. 4 illustrates a flowchart according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a fire shield safety system that can protect or a home or other buidiing from wildfires and other natural disasters. The following figures will describe the various components of the fire shield safety system. The various components include the infrared sensors, water control valves, rooftop rotors, controller, and application wihin the mobile device will work together to create a barrier of water around the home or building. The barrier of water can protect the building or home from any approaching wildfires and other disasters. Accordingly, the home or building can be equipped with an automatic safety system that can always protect the home or building at all times from wildfires and other natural disasters.

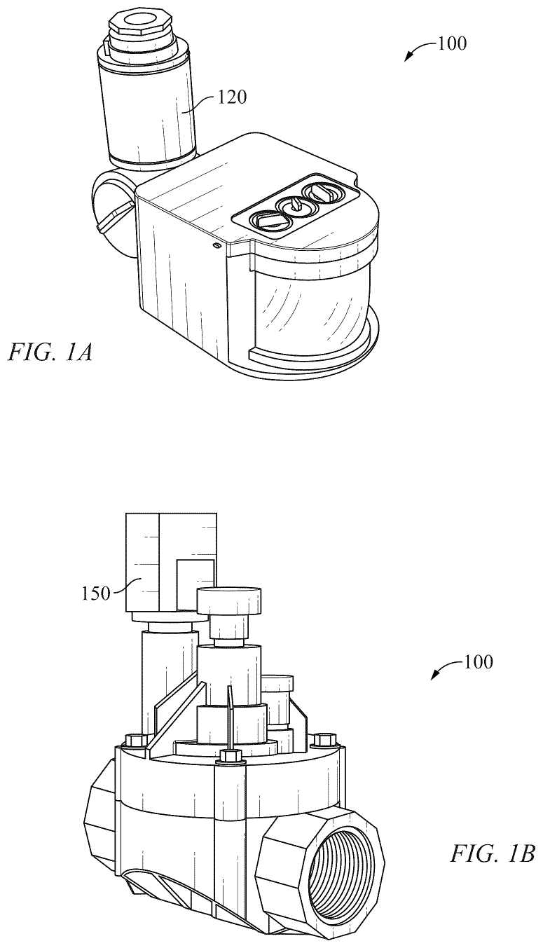

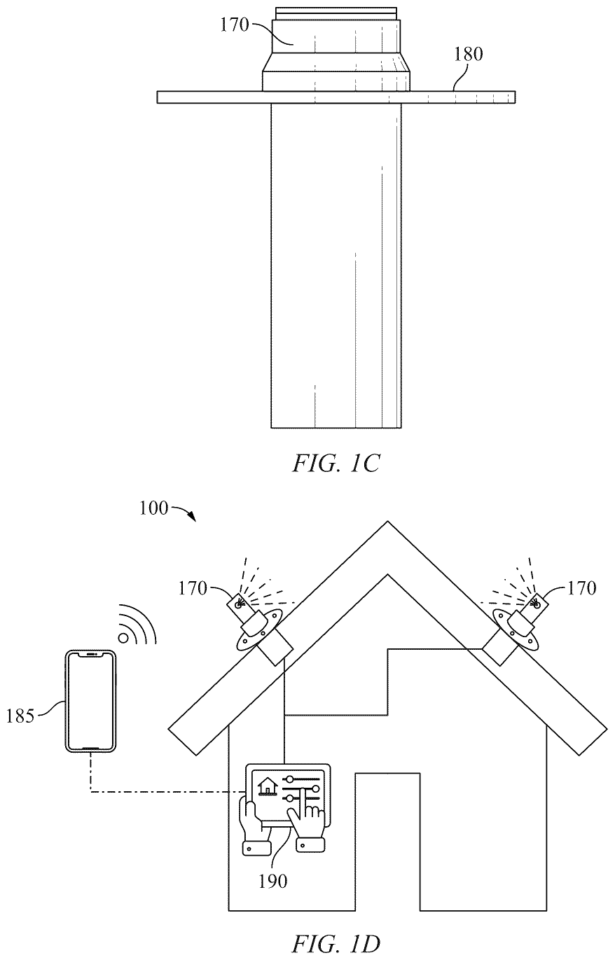

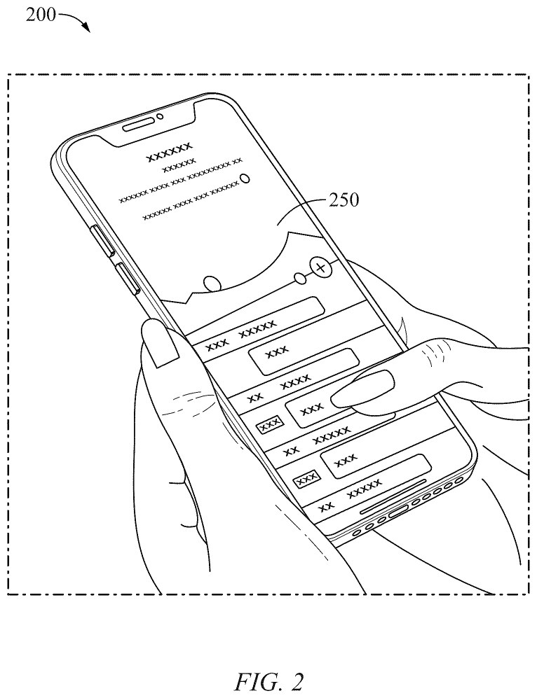

FIG. 1(A) illustrates a front view of a fire shield safety system 100 that illustrates an infrared sensor 120. The infrared sensor 120 can be placed at various points on the roof and other points on and around the housing structure along with other infrared sensors 120. The infrared sensor 120 can be configured to sense an increase in temperature in the air surrounding the home. When the temperature in the nearby area reaches or exceeds a maximum tempature, the infrared sensor 120, along with other infrared sensors 120 situated on the roof and around the home can send an alert to the controller or mobile device which is connected to each of the infrared sensors 120. The alert can tell the mobile device and controller that one or more wildfires and other disasters are approaching the building structure. The infrared sensors 120 can perform these tasks at any time of the day at any time interval.

FIG. 1(B) illustrates a front view of another aspect of the fire shield safety system 100. Another aspect of the fire shield safety system 100 can include water control valves 150. The water control valves 150 can be placed on or around the roof of the housing structure or building. The water control valves 150 can be situated in any position on or around the housing structure to where they can effectively provide water to the rooftop rotors on the roof of the housing structure. In some embodiments, the infrared sensors 120 will sense an increase in temperature or other factors that wildfires are approaching the housing structure. As such, the infrared sensors 120 can send an alert of the incoming wildfires to the controller and mobile device connected to both the infrared sensors 120 and the water control valves 150. The mobile device, using the synced fire shield safety application, will activate the water control valves 150 to provide water to the rooftop rotors. When the rooftop rotors are activated, the rooftop rotors will receive the water from the water control valves 150 to activate the water barrier around the housing structure. As such, in response to the alert or alerts from the infrared sensors 120, the water control valves 150 on the housing structure can be activated to assist the rooftop rotors by providing water to the rooftop rotors to create the water barrier around the housing structure.

Referring to FIG. 1(C), a side view of a further aspect of the fire shield safety system 100 is shown. The further aspect of the fire shield safety system 100 can include a rooftop rotor 170. Moreoever, a series of the rooftop rotors 170 can be positioned at various points on the roof of the housing structure. A rim 180 on each of the rooftop rotors 170 can secure the rootop rotors 170 on the roof of the building or housing structure. The rooftop rotors 170 can be configured to work in conjunction to create a barrier of water around the housing structure. The barrier of water around the housing structure can extend forty feet or more from the housing structure. The user can configure the rooftop rotors 170 to extend the watter barrier farther in response to multiple or larger wildfires or disasters.

Still referring to FIG. 1(C), in recap, the rooftop rotors 170 can work in conjunction with the infrared sensors 120 and the water control valves 150. The infrared sensors 120 can sense wildfires approaching the housing structure and alert the mobile device and controller. In response to the alerts, the mobile device or controller can activate the water control valves 150. The water control valves 150 can provide the water flow to the rooftop rotors 170 on the roof of the housing structure. The rooftop rotors 170 can work in conjunction to form a water barrier around the housing structure. The water barrier can extend at least forty feet from the housing structure. The length of the water barrier can be increased using the rooftop rotors 170 as well. The water barrier can extinguish any wildfires that come within close proximity of the housing structure. Further, the rooftop rotors 170 can continue to function for multiple time intervals until the wildfires have been extinguished and are no longer with close proximity of the housing structure.

Referring to FIG. 1(D), a further aspect of the fire shield safety system 100 is illustrated. The infrared sensors 120 can sense elevated temperatures in the area surrounding the housing structure, and identify incoming wildfires and disasters. In response, the infrared sensors 120 can send alerts to a mobile device 185 configured with the application, and a controller 190. With the mobile device 185, the mobile device can activate the water control valves 150 and the rooftop rotors 170 to enable the water barrier around the house to be created. Alternatively, a user can press an automatic button on the controller 190. When the controller 190 button is pushed, the water control valves 150 can supply the water to the rooftop rotors 170 to enable the rooftop rotors to form the water barrier surrounding the housing structure.

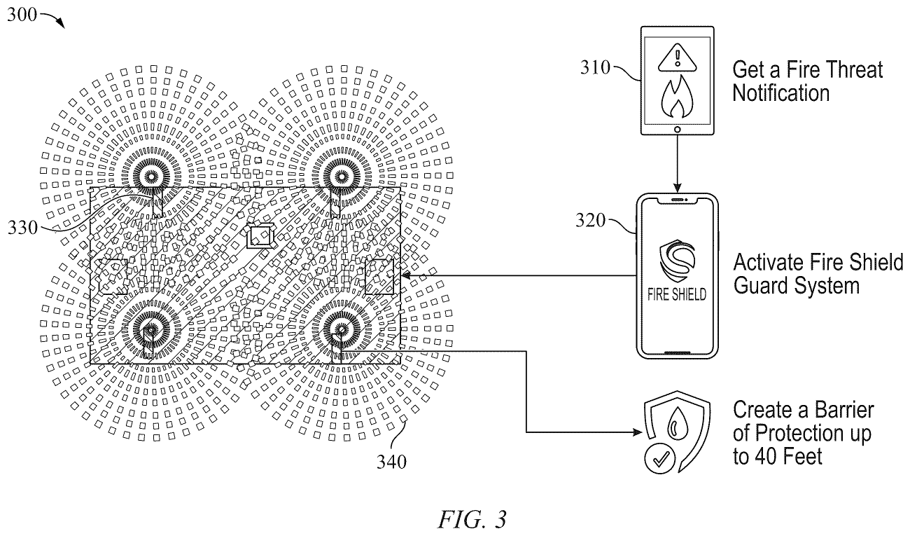

In reference to FIG. 2, a mobile device 200 is illustrated. The mobile device 200 can be configured with a fire shield safety application 250. The fire shield safety application 250 can configure the mobile device 200 to be connected to each aspect of the fire shield safety system configured on the housing structure. In other words, through the fire shield safety application 250, the mobile device 200 can be connected to the infrared sensors, the water control valves, and the rooftop rotors and also the controller.

Accordingly, still referring to FIG. 2, the infrared sensors on the roof and other portions of the housing structure can sense wildfires in close proximity to the housing structure. The infrared sensors can detect an increase in temperature in the surrounding air and area. When the temperature exceeds a limit or maximum level temperature, the infrared sensors collectively can send an alert of an incoming or possible wildfire or other natural disaster that is approaching the housing structure. In response to the alert, the fire shield safety application 250 can activate the water control valves and the rooftop rotors. Upon activation, the water control valves can provide the flow of water to the rooftop rotors. When the rooftop rotors receive the water flow, the rooftop rotors can work in conjunction to form a perimeter water barrier around the housing structure as the rooftop rotors continue to receive the water flow from the water control valves.

With respect to FIG. 2, the fire shield safety application 250 in some embodiments, can continue to activate the various components of the fire shield safety system to continuously provide the water barrier around the housing structure. The infrared sensors can keep sending alerts when additional wildfires or other diasters are within proximity to the housing structure. In response the fire shield safety application 250 can continue ensure that the various components of the fire shield safety system are activated. The water control valves can continue to provide water flow to the rooftop rotors. The rooftop rotors can continue to work collectively to provide the water barrier of forty feet or more more around the housing structure. The water barrier can also be increased to a greater distance if needed. The water barrier can continue to be provided as the wildfires and other disasters are within the proximity of the housing structure. When the wildfires or other diasters have been extinguished or put off, the fire shield safety application 250 can then shut down the rooftop rotors and water control valves using the mobile device or controller. However, should the infrared sensors sense other wildfires or other diasters coming within proximity of the housing structure, the infrared sensors can alert the mobile device 200 through the fire shield safety application 250, and the process of activation can be repeated. Moreover, the process of activating the fire shield safety system can occur in as many iterations as is required to extinguish wildfires and other disasters.

FIG. 3 illustrates a top view of the fire shield safety system 300 during an activation phase. The fire shield safety system 300 can be activated in response to wildfires and other diasters in proximity to the housing structure. The fire shield safety system 300 can include various components that work in conjunction to form the water barrier around the housing structure. When wildfires and other disasters are within proximity to the housing structure or if an abnormally high tempeture is sensed by the infrared sensors, the fire shield safety application can get a fire threat notification 310 that will be displayed on the mobile device 320 and on a controller. The mobile device 320 and the controller can control the functions of the water control valves and rooftop rotors 330 that are positioned on the housing structure. The mobile device 320 and controller can both therefore be used to activate and turn off the fire shield safety system 300.

Still referring to FIG. 3, the infrared sensors within the fire shield safety system 300 can also sense an increase in temperature in the surrounding air and area around the housing structure. Moroever, when the infrared sensors sense temperature levels that are above a maximum limit and consistent with wildfires and other natural disasters, the infrared sensors can send the fire threat notification 310 to the mobile device 320 and the controller. In response to receiving the fire threat notification 310, the mobile device 320 can activate the components of the fire shield safety system 300 that include the water control valves. The water control valves can be positioned on the roof and other points on the housing structure. The water control valves can provide the water flow to the rooftop rotors 330. When the rooftop rotors 330 receive the water flow, the rooftop rotors 330 can work collectively to create the water barrier 340 around the housing structure.

With respect to FIG. 3, rooftop rotors 330 can be positioned on various positions on the roof of the housing structure. When activated, the rooftop rotors 330 can receive the water flow consistently from the water control valves. In addition, the rooftop rotors 330 can collectively use the received water flow to create the water barrier around the housing structure to prevent the wildfires and other disasters from potentially affecting the housing structure. In some embodiments, the water barrier 340 around the housing structure can be approximately forty feet from the housing structure. In other embodiments, the water barrier 340 can be configured to be greater than forty feet from the housing structure. As such, the water barrier 340 will be at least forty feet from the housing structure. The rooftop rotors 330 and water control valves can also be adjusted to enable the water barrier 340 to be greater than forty feet. In some instances, multiple wildfires can be approaching the housing structure. As such, the water barrier 340 can thereby be configured to be greater than forty feet from the housing structure. The water barrier 340 can continuously flow until the infrared sensors within the fire shield safety system 300 detect that there is no longer a threat of wildfires or other disasters.

Referring again to FIG. 3, the mobile device 330 or controller can deactivate the fire shield safety system 300 after the water barrier 340 has extinguished any approaching wildfires or other disasters. In addition, the infrared sensors can continuously detect the temperature of the surrounding area. As such, the infrared sensors, in other time intervals, can sense when wildfires are approaching due to abnormal tempeatures in the sourroundg area. The infrared sensors can again send the fire threat notification 310 to the mobile device 320. In response, the mobile device 320 can use the fire shield safety application to activate the fire safety system 300, and thereby activate the water control valves and rooftop rotors 330. The process can be repeated as as many times as is required to prevent any wildfires or other diasters from affecting the housing structure.

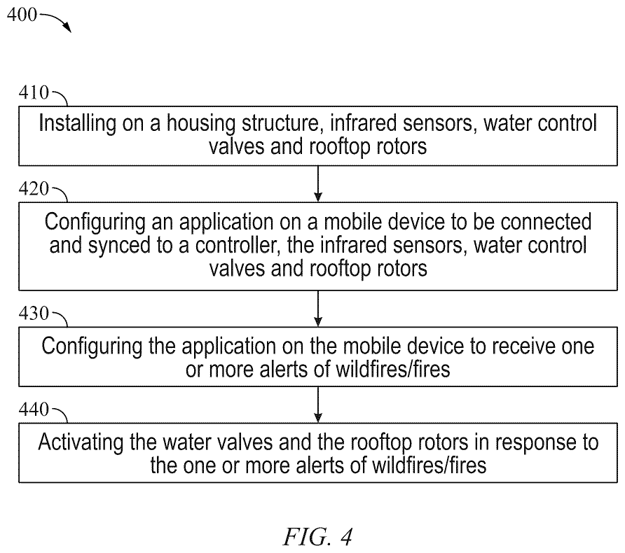

In reference to FIG. 4, a method 400 is illustrated in which a fire shield safety system is activated in response to receiving threats of wildfires or other disasters. The fire shield safety system can include infrared sensors, water control valves and rooftrop rotors that are positioned on the housing structure. At 410, the fire shield safety system is thereby installed by configuring the infrared sensors, water control valves, and rooftop rotors in their set positions on the housing structure. The infrared sensors can be configured to sense whether wildfires or other disasters are approaching the housing structure. The infrared sensors can sense high temperatures that exceed a temperature limit and can send an alert to a mobile device controller. The water control valves can provide water flow to the rooftop rotors. The rooftop rotors can be positioned at various points on the roof of the housing structure, and use the water flow to form a water barrier around the housing structure.

With reference to FIG. 4, at 420, a fire shield safety application can be configured on a mobile device and on a controller. The fire shield safety application can ensure that the mobile device and controller are connected to the infrared sensors, water control valves, and rooftop rotors. As such, when the infrared sensors sense wildfires approaching the housing structure, the mobile device and controller can receive a fire threat notification alert or alerts from the infrared sensors. Further, the mobile device and controller can then activate the water control valves and rooftop rotors.

In FIG. 4, at 430, the mobile device receives a fire threat notification from one or more of the infrared sensors positioned on the housing structure. The controller can receive ethe same fire threat nofication as well. When the infrared sensors sense temperatures well above normal, and determine that one or more wildfires or other disasters are approaching the housing structure, the infrared sensors can send alerts to the mobile device. Upon receving the alerts, the mobile device and controller are aware of the imminent threat of wildfires or disasters that are approaching the housing or building structure.

Referring to FIG. 4, at 440, in response to receiving the alerts from the infrared sensors, the mobile device can activate the fire shield safety system. The mobile device can activate the water control valves and the rooftop rotors using the fire shield safety application. The controller, using an automatic button, can also activate the water control valves and the rooftop rotors. The water control valves can provide the water flow to the rooftop rotors. When the rooftop rotors receive the water flow, the rooftop rotors can collectively form a water barrier around the housing structure. The water barrier can extend forty feet or more from the housing structure. The water barrier can continuously run until any approaching wildfires or other disasters have been extinguished. The mobile device or controller can then turn off the fire safety system when the threats of the wildfires have been addressed. Further, should the infrared sensors sense additional wildfires, the infrared sensors can send additional fire threat notification alerts to the mobile device. In response the mobile device or controller using the fire shield safety application can again intiate the fire shield safety system to ensure that the water barrier protects the houing structure and extinguishes the approaching wildfires.

Overall, the fire shield safety system provides a way to safely ensure housing and buildings from being adversely affected by wildfires and other disasters. The infrared sensors can automatically detect temperature abnormalities and send alerts to the mobile device. The mobile device and controller can always be connected to the various components of the fire shield safety system. In response to receiving the alerts, the mobile device or controller can activate the water control valves and rooftop rotors of the fire shield safety system to form the water barrier around the home or building. The mobile device or controller can deactivate the fire shield safety system after the wildfire and other disaster threats have been extinguished. In addition, the mobile device or controller can reactivate the fire shield safety system when additional threats have been reported by the infrared sensors.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method comprising:
installing at various positions on a housing structure, one or more water control valves, a series of rooftop rotors, and a series of infrared sensors to perform a series of functions;
configuring an application on a mobile device to be connected to a controller, the one or more water control values, the series of rooftop rotors, and the infrared sensors, wherein the application is configured to be synced to the one or more water control valves, the series of rooftop rotors, and the series of infrared sensors, and configured to receive alerts of any approaching fires from the series of infrared sensors to activate the one or more water control valves and the series of rooftop rotors in response to the received one or more alerts; and
activating the one or more water control valves and the series rooftop rotors to form a barrier around the housing structure.

2. The method of claim 1, further comprising:
receiving by the mobile device, the one or more alerts of wildfires approaching the housing structure.

3. The method of claim 1, further comprising:
configuring the barrier around the housing structure to be forty feet or more.

4. The method of claim 1, further comprising:
configuring the series of rooftop rotors to be positioned at various set points on a roof of the housing structure.

5. The method of claim 1, further comprising:
configuring the series of rooftop rotors to work in conjunction to form the barrier around the housing structure.

6. The method of claim 1, further comprising:
configuring the one or more water control valves, the series of rooftop rotors, and infrared sensors to act in unison as a fire safety shield on the housing structure.

7. The method of claim 1, further comprising:
configuring the infrared sensors on one or more exterior portions of the housing structure to sense one or more wildfires approaching the housing structure.

8. A method comprising:
installing a fire safety system on multiple portions of a housing structure, wherein various portions of the fire safety system are configured to perform set functions on and around the housing structure;
configuring a mobile device to be connected to the fire safety system, wherein an application within the mobile device is configured to be connected to the fire safety system and receive alerts from the fire safety system of one or more fires that are about to occur at or around the housing structure;
activating, by the mobile device, the fire safety system to create a perimeter barrier around the housing structure in response to the one or more fires.

9. The method of claim 8, further comprising:
initiating rotors on the housing structure to create the perimeter barrier of water to prevent the one or more fires from contacting the housing structure.

10. The method of claim 8, further comprising:
positioning water control valves in various positions on the housing structure to provide water to rooftop rotors to form the perimeter barrier around the housing structure.

11. The method of claim 8, further comprising:
receiving alerts from infrared sensors, positioned on the housing structure, of the one or more fires approaching the housing structure.

12. The method of claim 8, further comprising:
configuring a series of rotors on a roof of the housing structure to work in conjunction to form the barrier around the housing structure.

13. The method of claim 8, further comprising:
configuring the barrier around the housing structure to extend at least forty feet around the housing structure.

14. The method of claim 8, further comprising:
configuring a series of rotors on a roof of the housing structure to provide the barrier of water around the housing structure for one or more time periods to extinguish the one or more fires.

15. A fire safety system comprising:
infrared sensors positioned on exterior regions of a housing structure;
a mobile device configured with an application to connect the mobile device to a controller and the infrared sensors, wherein an uploading an initiation of the application configures the mobile device to receive alerts from the infrared sensors positioned on the exterior regions of the housing structure, wherein the alerts include information on incoming fires approaching the housing structure;
rotors positioned on a roof of the housing structure, and connected to the mobile device, wherein the rotors are activated by the mobile device using the application, wherein the activation of the rotors forms a water barrier around the housing structure.

16. The fire safety system of claim 15, further comprising:
a series of water control valves that are activated by the mobile device or the controller in response to the controller or mobile device receiving the alerts from the detectors.

17. The fire safety system of claim 15, wherein the rotors from the water barrier configured to surround an entire circumference of the housing structure.

18. The fire safety system of claim 15, wherein the mobile device activates water control valves to work in conjunction with the rotors in response to the received alerts from the detectors.

19. The fire system of claim 15, wherein the mobile device activates the rotors to from the water barrier to extend forty feet or more from the housing structure.

20. The fire system of claim 15, wherein the mobile device is configured to receive the alerts from the infrared sensors in multiple time intervals.
